(19) United States
(12) Patent Application Publication
(10) Pub. No.: US 2011/0069026 A1
(43) Pub. Date: Mar. 24, 2011

(54) TOUCH PANEL MODULE FOR PROVIDING ELECTRICALLY-STIMULATED SENSATION FEEDBACK

(75) Inventors: Chien-Cheng Chen, Fengshan City (TW); Chun-Lin Huang, Kaohsiung (TW); Yi-Fu Kuo, Kaohsiung (TW); Yann-Jyh Chang, Kaohsiung (TW)

(73) Assignee: EMERGING DISPLAY TECHNOLOGIES CO., LTD., Kaohsiung (TW)

(21) Appl. No.: 12/881,376

(22) Filed: Sep. 14, 2010

(30) Foreign Application Priority Data
Sep. 21, 2009 (TW) 098217355

(51) Int. Cl. G06F 3/041

(52) U.S. Cl. 345/173; 178/18.03

(57) ABSTRACT

A touch panel module has a touch panel, a sensation feedback panel, a control unit and a stimulating signal generating circuit. The sensation feedback panel is mounted on the touch panel and has multiple stimulating circuits arranged in a matrix configuration or a non-overlap configuration. The stimulating signal generating circuit electrically connects to the stimulating circuits and the control unit. When the control unit receives a touch signal produced by the touch panel, it controls the stimulating signal generating circuit to output stimulating currents to the stimulating circuits. When a user touches the stimulating circuits, the stimulating current can flow through the user's finger to electrically stimulate nerve, thereby achieving the sensation feedback effect to notice the user that the touch panel has been pressed properly to activate desired function.

### BACKGROUND OF THE INVENTION

1. Field of the Invention

The present invention relates to a touch panel module, especially to a touch panel module that is able to generate electrical stimulation as feedback information in response to user's operations on a touch panel.

2. Description of the Related Art

Either the resistive or capacitive type touch panel applied in electronic apparatus is manufactured as a full flat structure for artistic purpose. However, while operating the touch panel, users cannot feel the real sensations as touching practical buttons, keys, switches, etc. The users have to carefully watch the touch panel to see whether the touch panel responds exactly to activate designated functions. If the touch panel receives the user's commands but fails to respond immediately, the users may think that the touch panel has problems and touch again, which will further cause incorrect operations of the touch panel. To overcome the problem, attempts are made to incorporate vibrating function in the conventional touch panel to notice the user that the touch panel has been triggered.

Actuators or piezoelectric transformers (PZT) are often used in the touch panel to implement the vibrating function. With reference to FIG. 14, a motor-based actuator 50 is affixed on a frame 52 of a display 51. When a touch panel 53 above the display 51 is activated or triggered, the actuator 50 generates vibrations as feedback to notice users.

However, implementing the vibration function in the touch panel has the following shortcomings.

1. Integrating the actuator in the touch panel is difficult. The actuator must be separately and securely mounted on a proper structure near the touch panel, for example mounted on the frame 52.

In addition, mounting the piezoelectric transformers on the touch panel involves high-temperature manufacturing process and a glass substrate of the touch panel is unable to sustain such high temperature. Further, since the piezoelectric transformer is opaque and visible, it is unsuitable for the transparent touch panel.

2. The entire touch panel will experience the vibration. In other words, vibration movement cannot be limited in a local small region on the touch panel to particularly identify a touch point or multiple touch points where the user presses.

To overcome the shortcomings, the present invention proposes a touch panel module for providing electrical stimulating sensation to mitigate or obviate the aforementioned problems.

### SUMMARY OF THE INVENTION

The main objective of the present invention is to provide a touch panel module that generates electrical stimulation as the sensation feedback message to notice users that a touch panel has been successfully touched.

The touch panel module in accordance with the present invention comprises a touch panel, a sensation feedback panel, a control unit and a stimulating signal generating unit.

The touch panel is capable of producing a touch signal in response to a touch point.

The sensation feedback signal is mounted on the touch panel and comprises a second substrate, multiple first stimulating circuits formed on the second substrate, and multiple second stimulating circuits formed on the second substrate and electrically insulated from the first stimulating circuits.

The control unit is electrically connected to the touch panel and receives the touch signal to generate a touch-point coordinate signal based on the touch signal.

The stimulating signal generating unit is electrically connected to the control unit, electrically connected to the first stimulating circuits and the second stimulating circuits via a second flexible circuit board. The stimulating signal generating unit receives the touch-point coordinate signal and outputs stimulating currents to the first and second stimulating circuits where the touch point presents.

When a user presses the sensation feedback panel to indirectly activate the touch panel, the user's finger touches the sensation feedback panel and contacts at least one first stimulating circuit and at least one second stimulating circuit simultaneously. The touch panel accordingly generates and sends a touch signal to the control unit. Upon reception of the touch signal, the control unit outputs a touch-point coordinate signal to the stimulating signal generating unit. Therefore, the stimulating signal generating unit is able to produce stimulating currents transmitted to the sensation feedback panel where the user is pressing, thereby electrically stimulating the user's finger nerve. If the user feels the small stimulation, he or she can recognize the touch panel has been triggered to execute desired functions.

Other objectives, advantages and novel features of the invention will become more apparent from the following detailed description when taken in conjunction with the accompanying drawings.

### BRIEF DESCRIPTION OF THE DRAWINGS

FIG. 1 is a circuit block diagram of a touch panel module in accordance with the present invention;

FIG. 2 is a perspective view of the touch panel module in accordance with the present invention;

FIG. 3 is a plan view of a first embodiment of a touch panel used in the touch panel module in accordance with the present invention;

FIG. 4 is a plan view of a second embodiment of a touch panel used in the touch panel module in accordance with the present invention;

FIG. 5 is a plan view of a third embodiment of a touch panel used in the touch panel module in accordance with the present invention;

FIG. 6 is a plan view of a second embodiment of the touch panel module in accordance with the present invention;

FIG. 7 is a plan view of a third embodiment of the touch panel module in accordance with the present invention;

FIG. 8 is a plan view of a fourth embodiment of the touch panel module in accordance with the present invention;

FIG. 9 is a plan view of a fifth embodiment of the touch panel module in accordance with the present invention;

FIG. 10 is a partial cross sectional view of a seventh embodiment of the touch panel module in accordance with the present invention;

FIG. 11 is a partial cross sectional view of an eighth embodiment of the touch panel module in accordance with the present invention;

FIG. 12 is an operational view of the touch panel module in FIG. 1;

FIG. 13 is another operational view of the touch panel module in FIG. 1; and

FIG. 14 is a side plan view of a conventional touch panel equipped with an actuator.

### DETAILED DESCRIPTION OF THE PREFERRED EMBODIMENTS

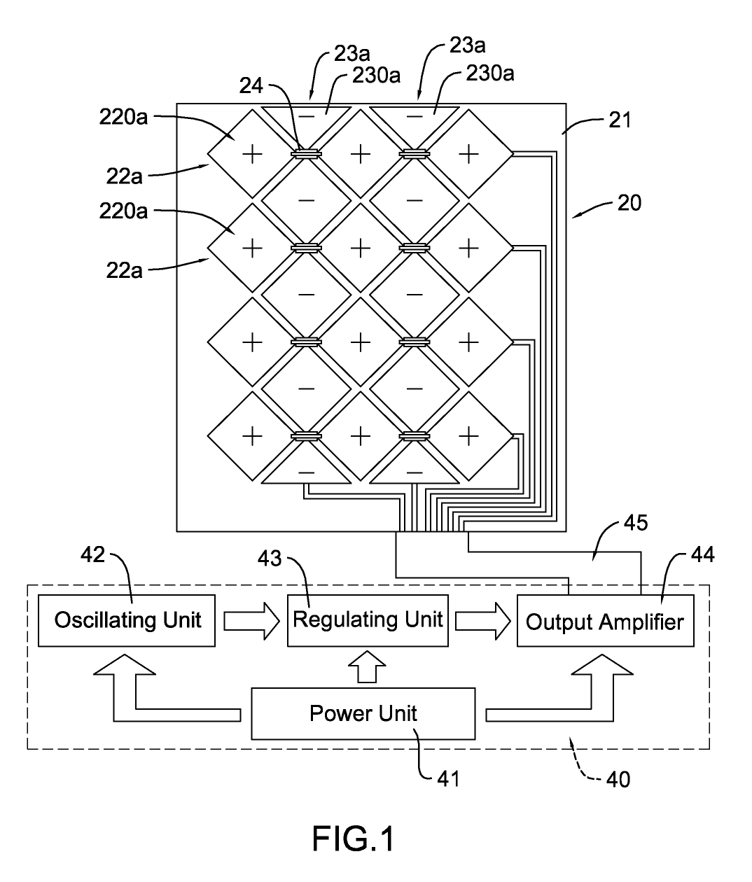

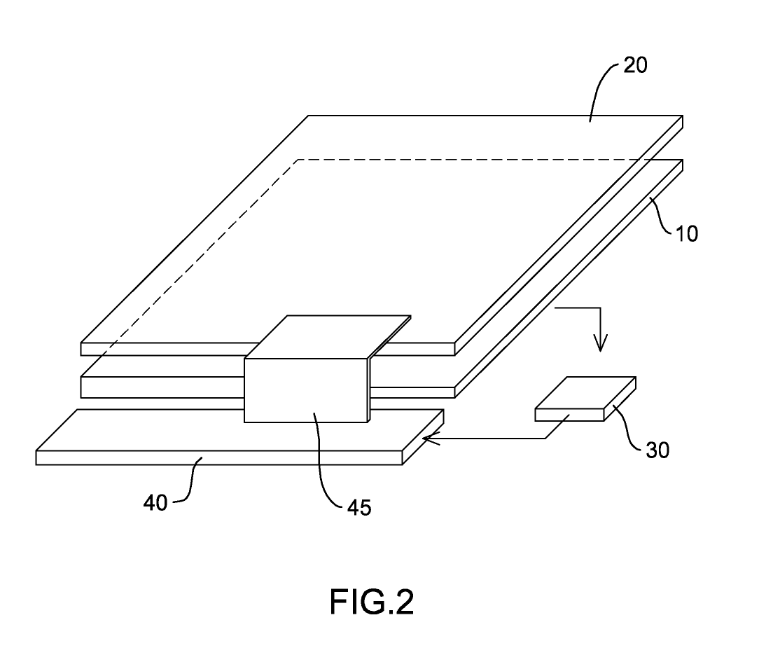

With reference to FIGS. 1 and 2, a first embodiment of a touch panel module in accordance with the present invention comprises a touch panel 10, a sensation feedback panel 20, a control unit 30 and a stimulating signal generating unit 40.

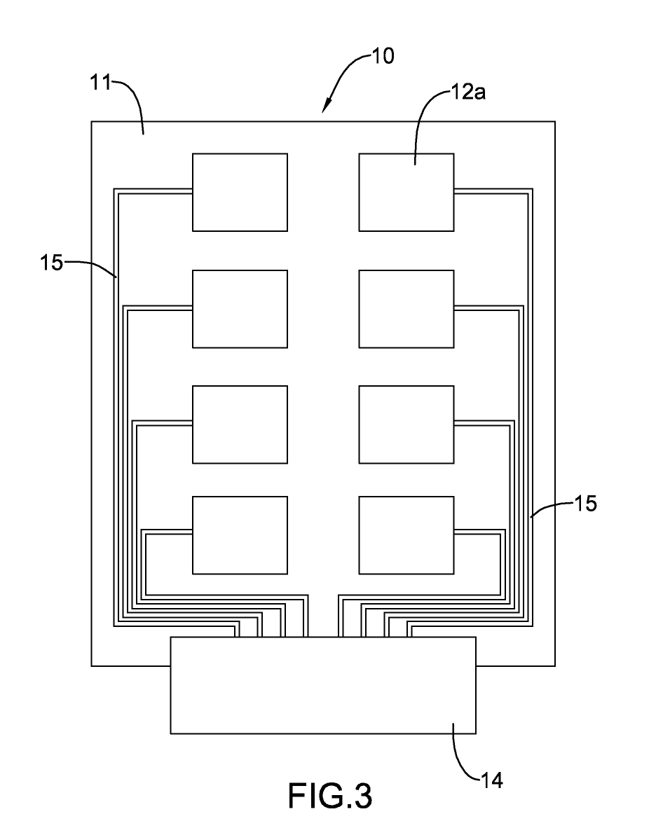

With reference to FIGS. 3 to 5, the touch panel 10 includes various types and produces a touch signal in response to the presence of a touch. The touch panel 10 in FIG. 3 comprises a first substrate 11, multiple first electrodes 12a formed on the first substrate 11, and a first flexible circuit board 14 attached at one edge of the first substrate 11 and electrically connected to the first electrodes 12a by wires 15.

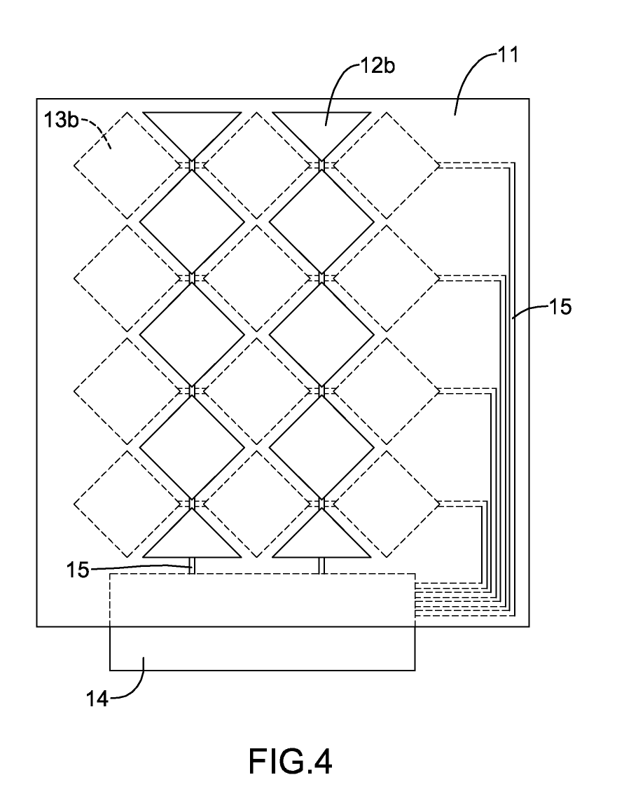

The touch panel 10 in FIG. 4 includes a first substrate 11 having a top surface and a bottom surface, multiple first electrodes 12b formed on the top surface of the first substrate 11, multiple second electrodes 13b formed on the bottom surface, and a first circuit board 14 attached at the first substrate 11. The first electrodes 12 are connected to form multiple electrode strings and each electrode string is electrically connected to the first substrate 11. The second electrodes 13 are connected to form multiple electrode strings and each electrode string is electrically connected to the first substrate 11. The electrode strings on the opposite surface of the first substrate 11 may be disposed across each other to form a matrix configuration.

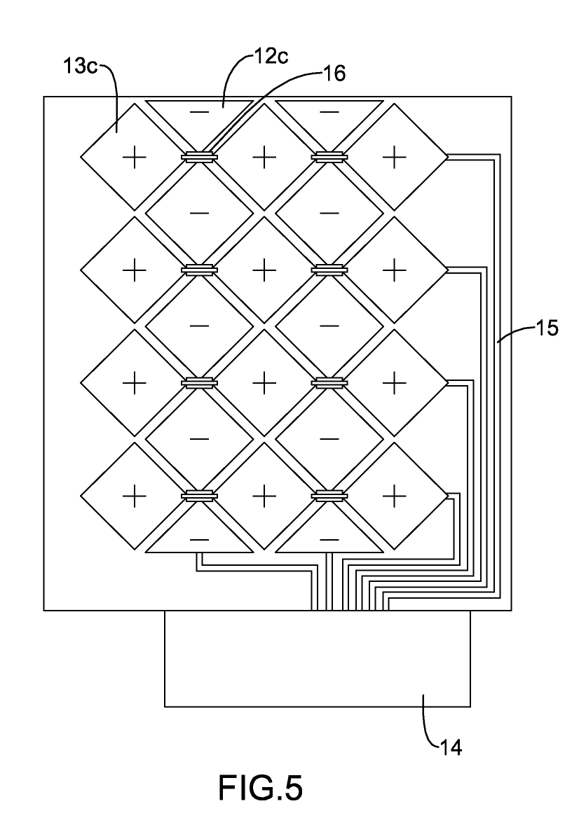

With reference to FIG. 5, the touch panel 10 comprises a first substrate 11, multiple first electrodes 12c and second electrodes 13c formed on the same surface of the first substrate 11, and a first flexible circuit board 14 mounted on the first substrate 11. The first electrodes 12, for example as X-axis electrodes, are connected to form multiple electrode strings and each electrode string is electrically connected to the first substrate 11. The second electrodes 13, for example Y-axis electrodes, are connected to form multiple electrode strings and each electrode string is electrically connected to the first substrate 11. The two types of electrode strings on the same surface of the first substrate 11 are disposed across each other but electrically-insulated to form a matrix configuration. Each intersection between the X-axis electrode string and Y-axis electrode string is provided with an insulating layer 16 to isolate the two different electrode strings and to prevent short circuits.

The sensation feedback panel 20 is mounted above the touch panel 10 and comprises a second substrate 21, multiple first stimulating circuits 22a and multiple second stimulating circuits 23a. Both the first stimulating circuits 22a and multiple second stimulating circuits 23a are formed on the substrate 21. The first stimulating circuits 22a and multiple second stimulating circuits 23a are preferably made of indium tin oxide (ITO) because of its electrical conductivity and optical transparency.

In the first embodiment, each of the first stimulating circuits 22a is an X-axis stimulating circuit that includes multiple X-axis electrodes 220a and multiple X-axis wires connecting the X-axis electrodes 220a. Each of the second stimulating circuits 23a is a Y-axis stimulating circuit that comprises multiple Y-axis electrodes 230a and multiple Y-axis wires connecting the Y-axis electrodes 230a. The second stimulating circuits 23a non-electrically intersect the first stimulating circuits 22a to form a matrix configuration, wherein an insulating layer 24 is provided at each intersection between the X-axis wire and the Y-axis wire to accomplish insulation effect.

In addition to the matrix configuration as shown in FIGS. 1 and 2, the foregoing first stimulating circuits and the second stimulating circuits can be arranged in a non-overlap configuration without the insulating layer 24.

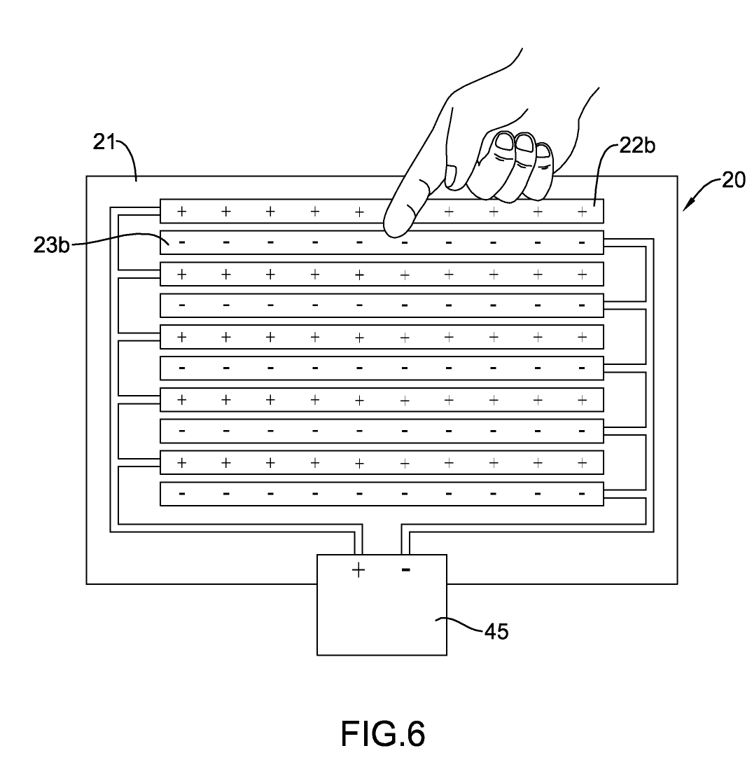

With reference to FIG. 6, the first stimulating circuits 22b and the second stimulating circuits 23b in the second embodiment are arranged on the substrate alternately without overlap. In comparison to the first embodiment, the first stimulating circuits 22b and the second stimulating circuits 23b can be simultaneously fabricated on the through a single lithography process. The first stimulating circuits 22b and the second stimulating circuits 23b are straight lines with equal width. The preferable width of each first stimulating circuit 22b and each second stimulating circuit 23b approximates to three to six millimeters (mm). The gap between adjacent stimulating circuits 22b, 23b is about one to three millimeters in width.

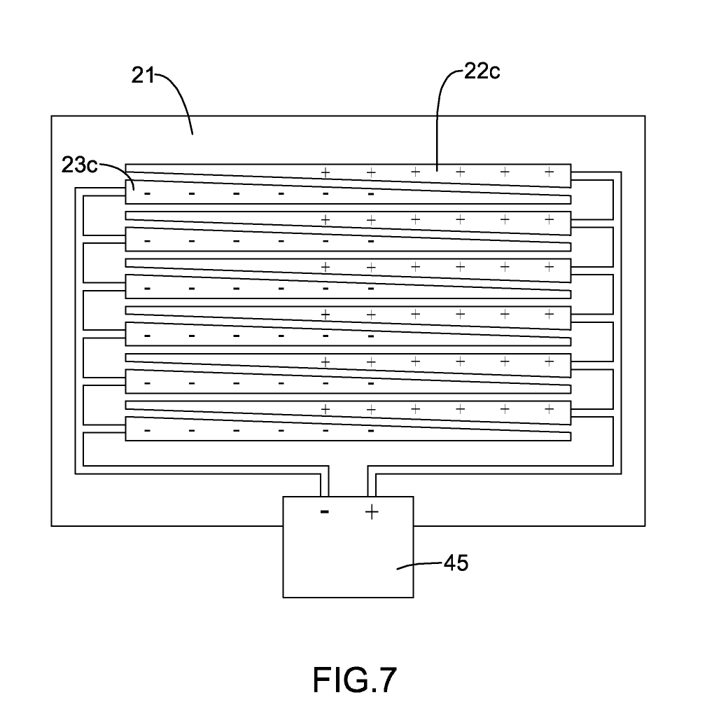

With reference to FIG. 7, each of the first stimulating circuits 22c and the second stimulating circuits 23c in the third embodiment is a tapered line with a narrow end and a wide end. Similar to the second embodiment, the wide end is about three to six millimeters in width, and the gap between adjacent stimulating circuits 22c, 23c is also about one to three millimeters.

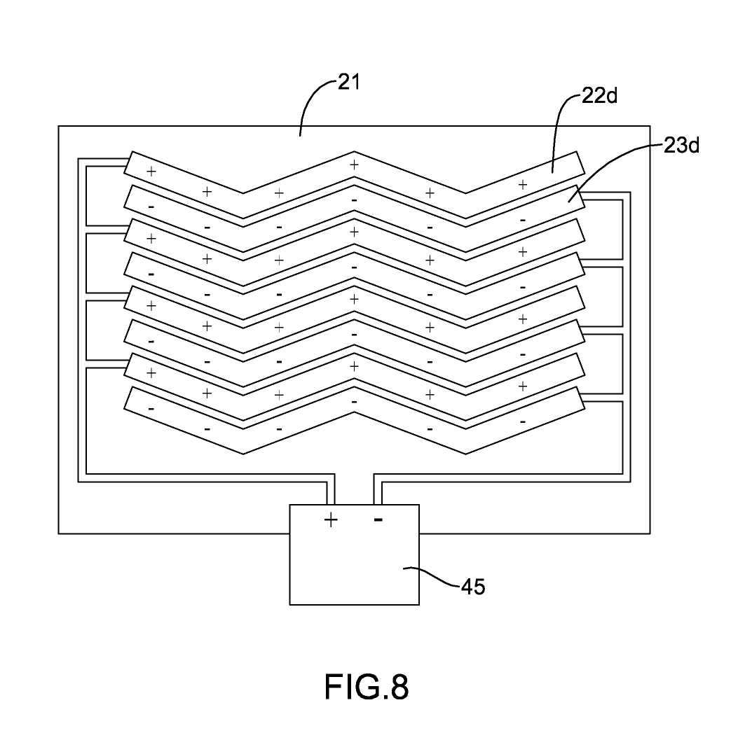

With reference to FIG. 8, the each of the first stimulating circuits 22d and the second stimulating circuits 23d in the fourth embodiment is a serrated line with equal width. The width of each first stimulating circuit 22d and each second stimulating circuit 23d approximates to three to six millimeters. The gap between adjacent stimulating circuits 22d, 23d is about one to three millimeters in width.

As shown in FIGS. 6 to 8 the first and second stimulating circuits 22b-22d, 23b-23d are not limited to particular shapes as long as each stimulating circuit and the gap have reasonable widths.

The sensation feedback panel 20 usually corresponds to the touch panel 10 in shape, and preferably both are rectangular in shape. The first stimulating circuits 22b-22d and the second stimulating circuits 23b-23d can be formed on the second substrate 21 lengthwise and parallel to the long edge of the second substrate 21. The flexible circuit board 45 can be attached at the long edge of the second substrate 21.

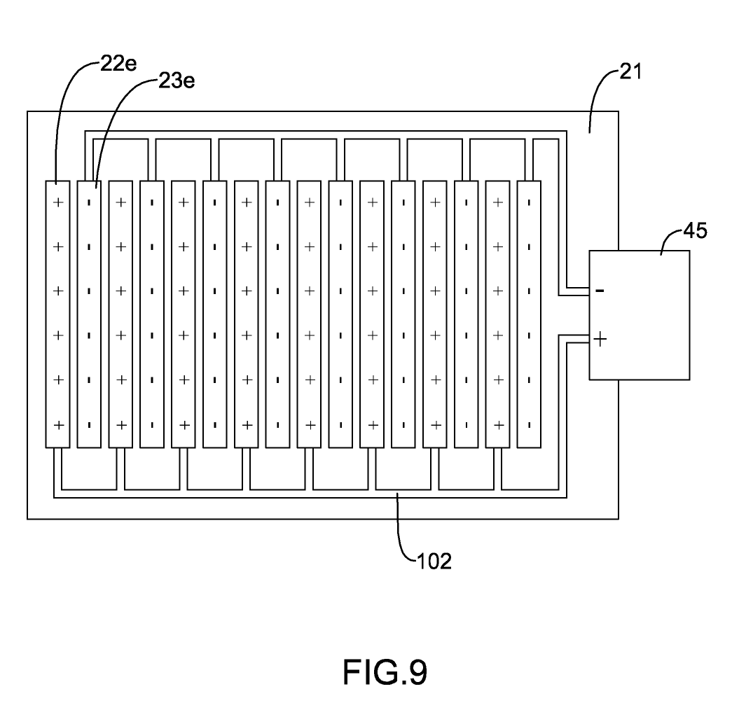

With further reference to FIG. 9, the first stimulating circuits 22e and the second stimulating circuits 23e can be parallel to the short edge of the second substrate 21 in the fifth embodiment. The flexible circuit board 45 can be mounted at the short edge of the second substrate 21.

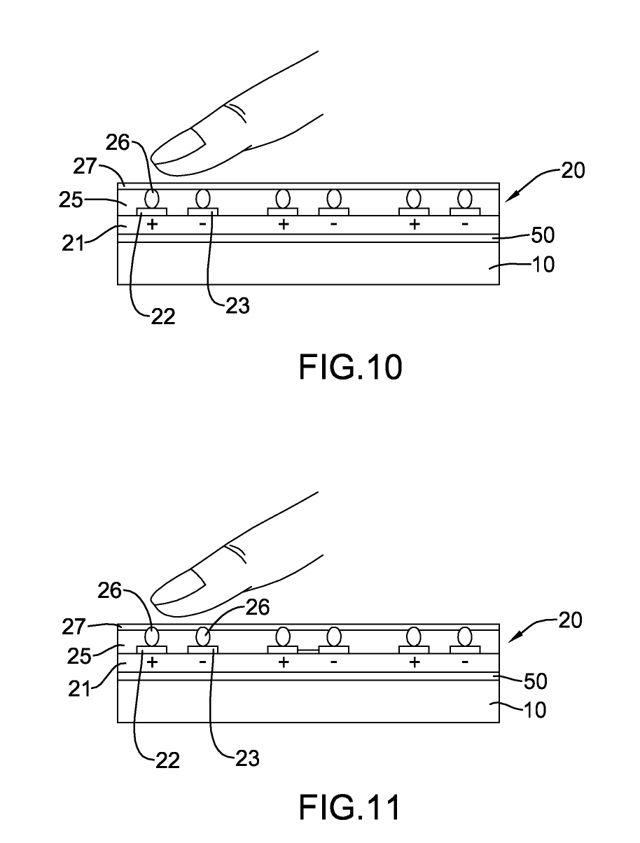

With reference to FIG. 10, the sensation feedback panel 20 can be affixed on the touch panel 10 via an adhesive layer 50. The sensation feedback panel 20 can further has a transparent glue layer 25 and a transparent protecting layer 27. The transparent glue layer 25 is spread on the second substrate 21 to cover the first stimulating circuits 22 and the second stimulating circuits 23. The transparent glue layer 25 includes conduct particles 26 that possess high electrical conductivity in a vertical direction, but provide good electrical insulation in a horizontal direction. The transparent glue layer 25 can be made of an anisotropic conductive film (ACF). The transparent protection layer 27 is formed on the transparent glue layer 25 to protect the first stimulating circuits 22 and the second stimulating circuits 23 from damage.

In the seventh embodiment of FIG. 10, the transparent glue layer 25 is thick enough to cover the conduct particles 26 completely. Alternately, the thickness of the transparent glue layer 25 can be smaller than the size of the conduct particles 26 as shown in FIG. 11 to partially expose the conduct particles 26. The preferable thickness of the transparent glue layer 25 should be more than one micrometer. The thickness of the transparent protecting layer 27 is about 0 to 1 micrometer.

With reference to FIGS. 1 and 2, the control unit 30 is connected to the touch panel 10 and receives the touch signal generated by the touch panel 10. After processing the touch signal, the control unit 30 outputs a touch-point coordinate signal to the stimulating signal generating unit 40. The touch-point coordinates signal may comprise the coordinates information of one or more touch points.

The stimulating signal generating unit 40 is connected to the control unit 30 and also connected to the sensation feedback panel 20 via the flexible circuit board 45. The stimulating signal generating unit 40 receives the touch-point coordinates signal and accordingly outputs stimulating currents to the first stimulating circuits 22a and the second stimulating circuits 23a where the touch points are located.

The stimulating signal generating unit 40 comprises a power unit 41, an oscillating unit 42, a regulating unit 43 and an output amplifier 44. The power unit 41 generates operating voltages. The oscillating unit 42 receives the operating voltage and outputs a periodic signal with a constant frequency. The regulating unit 43 regulates the periodic signal to form an electrical-stimulation signal suitable for stimulating human body. The output amplifier 44 receives the electrical-stimulation signal and accordingly produces constant voltages or constant currents that are transmitted to the corresponding first stimulating circuits 22a and the second stimulating circuits 23a where the user touches.

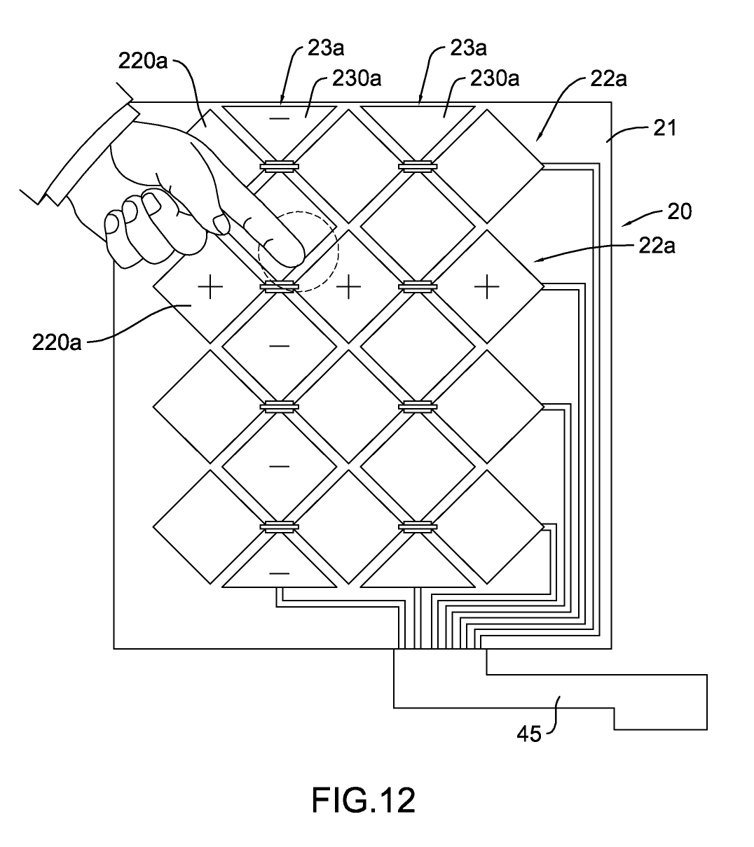

With reference to FIGS. 6 and 10 to 12, when a user presses the sensation feedback panel 20 to indirectly activate the touch panel 10, the user touches the sensation feedback panel 20 and contacts at least one first stimulating circuit 22a-22e and at least one second stimulating circuit 23a-23e simultaneously. Thus, the control unit 30 outputs the touch-point coordinate signal to the stimulating signal generating unit 40. Upon reception of the touch-point coordinate signal, the stimulating signal generating unit 40 outputs stimulating currents to the touch point where the user is pressing, thereby electrically stimulating the user's finger nerve.

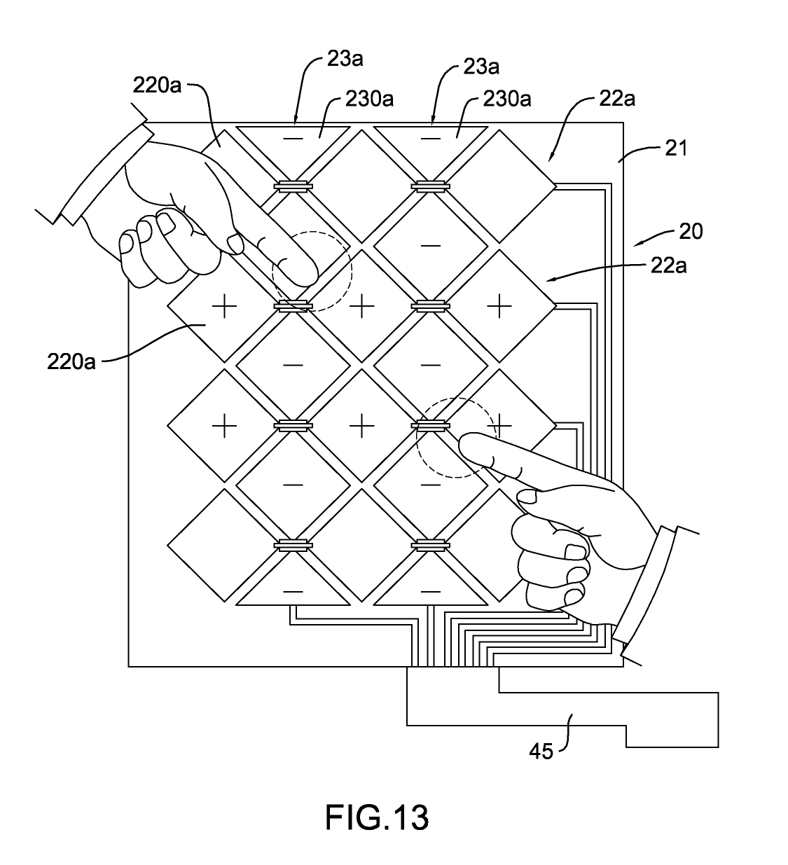

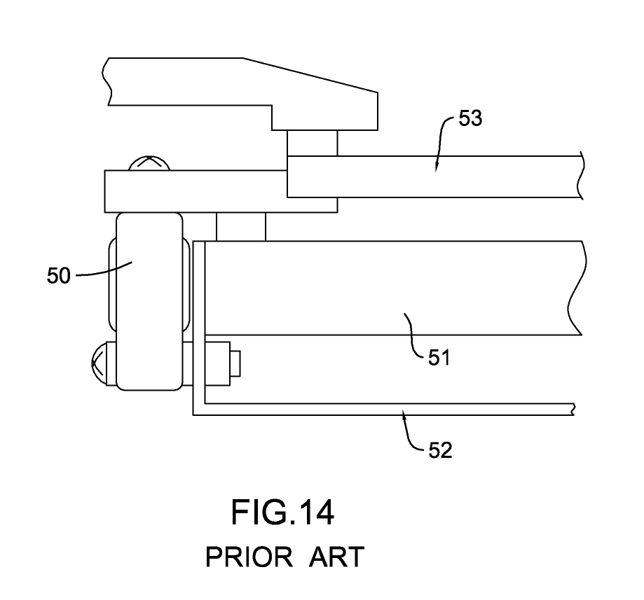

With reference to FIG. 13, when two or more fingers make contact with the sensation feedback panel 20 at the same time, the touch-point coordinate signal transmitted from the control unit 30 to the stimulating signal generating unit 40 has coordinates information of two or more touch-points. The stimulating signal generating unit 40 outputs stimulating currents to different positions on the feedback panel 20 based on the coordinates information. Therefore, the user's fingers can feel electrical stimulation at the same time.

In short, the touch panel module in accordance with the present invention has the following advantages.

1. The sensation feedback panel can be mounted on the touch panel easily, for example by the adhesive layer. When a user operates the touch panel module and contacts the sensation feedback panel, electrical stimulation is used as the feedback information to identify whether the user has actually touched or not.

2. The electrical stimulation is limited at the local position where the user touches. For more than one touch-points, the sensation feedback panel is able to produce multiple electrical stimulations respectively.

3. In comparison to the matrix configuration, the non-overlapped configuration of the stimulating circuits simplifies the manufacturing processes of the stimulation feedback panel because of the omission of the insulating layer.

4. The transparent glue layer and the transparent protecting layer prevent the user from directly touching the stimulating circuits to avoid possible damage.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A touch panel module providing electrically-stimulated sensation feedback comprising:
a touch panel capable of producing one or more touch signals in response to presence of one or more touch points;
a sensation feedback panel mounted on the touch panel and comprising
a second substrate;
multiple first stimulating circuits formed on the second substrate; and
multiple second stimulating circuits formed on the second substrate and electrically insulated from the first stimulating circuits;
a control unit electrically connected to the touch panel to receive the one or more touch signals and generating a touch-point coordinate signal based on the one or more touch signals; and
a stimulating signal generating unit electrically connected to the control unit, electrically connected to the first stimulating circuits and the second stimulating circuits via a second flexible circuit board, receiving the touch-point coordinate signal, and outputting stimulating currents to the first stimulating circuits and the second stimulating circuits where the one or more touch points presents.

2. The touch panel module as claimed in claim 1, wherein each of the first stimulating circuits is an X-axis stimulating circuit that includes multiple X-axis electrodes connected by multiple X-axis wires; each of the second stimulating circuits is a Y-axis stimulating circuit that comprises multiple Y-axis electrodes connected by multiple Y-axis wires; and the first stimulating circuits non-electrically intersect the second stimulating circuits to form a matrix configuration.

3. The touch panel module as claimed in claim 1, the touch panel module as claimed in claim 1, wherein the first stimulating circuits and the second stimulating circuits are alternately formed on the second substrate without overlap.

4. The touch panel module as claimed in claim 3, wherein the first stimulating circuits and the second stimulating circuits are in the form of straight lines with equal width.

5. The touch panel module as claimed in claim 3, wherein the first stimulating circuits and the second stimulating circuits are in the form of tapered straight lines.

6. The touch panel module as claimed in claim 3, wherein the first stimulating circuits and the second stimulating circuits are in the form of serrated lines with equal width.

7. The touch panel module as claimed in claim 3, wherein each first stimulating circuit and each second stimulating circuit have a width about three to six millimeters, and each first stimulating circuit is separated from an adjacent second stimulating circuit by a distance about one to three millimeters.

8. The touch panel module as claimed in claim 1, wherein the sensation feedback panel further comprises:
a transparent glue layer formed on the second substrate and covering the first stimulating circuits and the second stimulating circuits;
multiple conduct particles mixed and distributed in the transparent glue layer; and
a transparent protection layer formed on the transparent glue layer.

9. The touch panel module as claimed in claim 2, wherein the sensation feedback panel further comprises:
a transparent glue layer formed on the second substrate and covering the first stimulating circuits and the second stimulating circuits;
multiple conduct particles mixed and distributed in the transparent glue layer; and
a transparent protection layer formed on the transparent glue layer.

10. The touch panel module as claimed in claim 3, wherein the sensation feedback panel further comprises:
a transparent glue layer formed on the second substrate and covering the first stimulating circuits and the second stimulating circuits;
multiple conduct particles mixed and distributed in the transparent glue layer; and
a transparent protection layer formed on the transparent glue layer.

11. The touch panel module as claimed in claim 7, wherein the transparent glue layer has a thickness more than one micrometer, and the transparent layer has a thickness about 0 to 1 micrometer.

12. The touch panel module as claimed in claim 8, wherein the transparent glue layer has a thickness more than one micrometer, and the transparent layer has a thickness about 0 to 1 micrometer.

13. The touch panel module as claimed in claim 9, wherein the transparent glue layer has a thickness more than one micrometer, and the transparent layer has a thickness about 0 to 1 micrometer.

14. The touch panel module as claimed in claim 2, wherein the touch panel comprises:
a first substrate;
multiple first electrodes formed on one surface of the first substrate; and
a first flexible circuit board mounted on the first substrate and electrically connected to the multiple first electrodes.

15. The touch panel module as claimed in claim 3, wherein the touch panel comprises:
a first substrate;
multiple first electrodes formed on one surface of the first substrate; and
a first flexible circuit board mounted on the first substrate and electrically connected to the multiple first electrodes.

16. The touch panel module as claimed in claim 2, wherein the touch panel comprises:
a first substrate having a top surface and a bottom surface;
multiple first electrodes formed on the top surface of the first substrate;
multiple second electrodes formed on the bottom surface of the first substrate; and
a first flexible circuit board mounted on the first substrate and electrically connected to the first electrodes and the second electrodes.

17. The touch panel module as claimed in claim 3, wherein the touch panel comprises:
a first substrate having a top surface and a bottom surface;
multiple first electrodes formed on the top surface of the first substrate;
multiple second electrodes formed on the bottom surface of the first substrate; and
a first flexible circuit board mounted on the first substrate and electrically connected to the first electrodes and the second electrodes.

18. The touch panel module as claimed in claim 2, wherein the touch panel comprises:
a first substrate having a surface;
multiple first electrodes and multiple second electrodes formed on the surface of the first substrate, the first electrodes and the second electrodes are disposed to form a matrix configuration; and
a first flexible circuit board mounted on the first substrate and electrically connected to the first electrodes and the second electrodes.

19. The touch panel module as claimed in claim 3, wherein the touch panel comprises:
a first substrate having a surface;
multiple first electrodes and multiple second electrodes formed on the surface of the first substrate, the first electrodes and the second electrodes are disposed to form a matrix configuration; and
a first flexible circuit board mounted on the first substrate and electrically connected to the first electrodes and the second electrodes.

20. The touch panel module as claimed in claim 1, wherein the stimulating signal generating unit comprises:
a power unit for generating operating voltages;
an oscillating unit receiving the operating voltage and outputting a periodic signal with a constant frequency;
a regulating unit regulating the periodic signal to form an electrical-stimulation signal suitable for stimulating human body; and
an output amplifier receiving the electrical-stimulation signal and accordingly produces constant voltages or constant currents that are transmitted to the corresponding first stimulating circuits and the second stimulating circuits where the one or more touch points present.
